(19) United States
(12) Patent Application Publication
(10) Pub. No.: US 2010/0186053 A1
(43) Pub. Date: Jul. 22, 2010

(54) Methods for Managing Content for Consumer Electronic Devices

(75) Inventors: Xu Zhang, Beijing (CN); Yixin Yang, Beijing (CN); Wei Qi, Palo Alto, CA (US)

Correspondence Address: Venture Pacific Law, PC, 5201 Great America Parkway, Suite 270, Santa Clara, CA, 95054, US

(73) Assignee: AMLOGIC CO., LTD., Santa Clara, CA (US)

(21) Appl. No.: 12/355,724

(22) Filed: Jan. 16, 2009

(51) Int. Cl. H04N 7/173

(52) U.S. Cl. 725/93

(57) ABSTRACT

The present invention relates to methods for managing content for a consumer electronic device (“CED”) via one or more networks, wherein the CED being uniquely identifiable, comprising the steps of: providing a server, wherein the server being connectable to the CED; connecting remotely by a user device to the server via the networks; providing by the user device to the server a content request for the CED, wherein the content request requesting a content and the content being located at one or more locations; requesting by the server for the locations of the content; providing by the server to the CED the locations of the content; and fetching the content by the CED from the locations of the content.

### FIELD OF INVENTION

This invention relates to methods for managing content for consumer electronic devices. In particular, this invention relates to methods for remote management of content for consumer electronic devices, such as televisions, set-top boxes, and digital picture frames, via one or more networks.

### BACKGROUND

The Internet is a worldwide, publicly accessible series of interconnected computer networks. Since its inception, the number of nodes, such as computers, servers, and other devices, connected to the Internet has increased dramatically. As a result, a tremendous amount of content is available on the Internet. The ability to easily and conveniently provide this content for use in consumer electronic devices (“CEDs”), such as televisions, digital picture frames (“DPFs”), computers, set-top boxes, mobile telephones, MP3 players, digital video recorders, DVD players, VHS players, digital cameras, camcorders, and other CEDs, remains an ongoing goal.

For many decades, the television has been the primary consumer electronic device in households for entertainment and news. In its infancy, television was a time-dependent, fleeting medium. It acted on the schedules of the companies that broadcasted the television signals or that operated the cable connections. The television users' dependence on the broadcast schedules lessened with the invention of programmable video recorders, such as videocassette recorders (“VCRs”) and digital video recorders (“DVRs”). With these new technologies, television users could watch programs on their own schedules once the programs were recorded.

Due to the advent of the Internet, content can now be provided to televisions via the Internet by using video on demand (“VOD”) systems and multimedia streaming systems. Television users can access this tremendous amount of content by connecting to the Internet, searching for particular content, and downloading that content into a medium that can be viewed and heard on their television set.

FIG. 1 illustrates the components of a prior art system for providing content to a television by searching for content and downloading that content via the Internet. Referring to FIG. 1, a user 100 can search for video content on the Internet and download that video content to a computer 102. The user 100 can then display that downloaded content on a television 106 by outputting the downloaded content from the computer 102 to the television 106 through a direct connection to audio and video inputs of the television 106, a coaxial cable input of the television 106, a high definition multimedia interface (“HDMI”) input of the television 106, or other television 106 input means. Alternatively, the user 100 can copy the video content to a storage medium, such as a DVD, to play on a device, such as a DVD player, to output the downloaded video content to the television 106.

There are several drawbacks to using a prior method for providing content to a television. If a computer and a television do not have compatible audiovisual inputs and outputs, then the content may not be played on the television using a direct connection. Furthermore, the process of having to search for content, downloading that content, and copying that content to a storage medium for display on a television can be very complicated and time consuming. The process may be too daunting to undertake for some television users due to their lack of knowledge or patience needed for setting up their televisions. Therefore, it is necessary to find simpler and more convenient methods for providing content via one or more networks to CEDs, such as televisions and DPFs.

FIG. 1 also illustrates an additional prior art method for providing content via the Internet to a television by using a VOD service for televisions. The VOD service for televisions is designed to allow a television user the ability to select and watch a desired program at any time. Referring to FIG. 1, a VOD server 108 takes a request for video content from the user via a set-top box 104. The VOD server 108 locates the requested video content and transmits the requested video content via the Internet to the set-top box 104. The set-top box 104 may then download that video content for playback on a television 106.

Generally, when a television user requests content from a VOD server, the VOD server must search for that video content on its internal storage. If the requested content can be found, then that requested content can be uploaded or streamed to the user. However, the content stored on a VOD server may be a small fraction of the content that is available via the Internet. Thus, many requests for video content might not be found by the VOD server.

When a plurality of television users concurrently accesses the VOD server, the VOD server may become overloaded, thereby reducing the download speed. When the VOD server is seriously overloaded, some televisions and set-top box systems are disconnected from the VOD server, thus leading to a serious deterioration of service quality.

Therefore, it is desirable to find methods for providing content via one or more networks to consumer electronic devices, such as televisions, set-top boxes, or digital picture frames, where a larger collection of content can be made available to a television user via the networks, and where such content can be downloaded in a simple and efficient manner for playback on a consumer electronic device.

### SUMMARY OF INVENTION

An object of this invention is to provide easier and more convenient methods for managing content for a CED.

Another object of this invention is to provide methods for searching for user requested content for playback on a CED by searching a plurality of peer-to-peer (“P2P”) networks for the requested content.

Briefly, this invention relates to methods for managing content for a consumer electronic device (“CED”) via one or more networks, wherein said CED being uniquely identifiable, comprising the steps of: providing a server, wherein said server being connectable to said CED; connecting remotely by a user device to said server via said networks; providing by said user device to said server a content request for said CED, wherein said content request requesting a content and the content being located at one or more locations; requesting by said server for the locations of the content; providing by said server to said CED the locations of the content; and fetching the content by said CED from the locations of the content.

An advantage of this invention is that managing content for a CED is made easier and more convenient.

Another advantage of this invention is that user requested content can be searched for on a plurality of peer-to-peer networks for playback on a CED.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates prior art methods for providing content to a television via the Internet.

FIG. 2 illustrates the components of an embodiment of this invention for providing content to a television via the Internet.

FIG. 3 illustrates a television having a variety of connective capabilities and storage capabilities.

FIG. 4 illustrates the components of an embodiment of this invention for providing content to a digital picture frame via the Internet.

FIG. 5 illustrates a process flow for providing content to a television from a variety of sources.

FIG. 6a illustrates the components of an embodiment of this invention, where a television connected to one or more P2P networks can search for content and download content from peers on the one or more P2P networks.

FIG. 6b illustrates a process flow for searching for user requested files on one or more P2P networks by searching one or more P2P resource search engines for the user requested files.

FIG. 7a illustrates five queues used for managing the download for a requested file.

FIG. 7b illustrates the process flow for utilizing the generated queues in downloading from the received peers.

FIG. 8a illustrates a television remote control that can be used as an input device for the purposes of this invention.

FIGS. 8b-8c illustrate different television remote control configurations that can be used as input devices for the purpose of this invention.

FIG. 9 illustrates a television remote control with a mapping of alphanumeric characters to specified buttons on the television remote control.

FIG. 10a illustrates the results of a television user using a predictive text input method to input video titles into the search menu of a user interface (“UI”), where that UI is displayed on the television.

FIG. 10b illustrates the results of a television user using an associative text input method to input video titles into the search menu of a UI, where that UI is displayed on the television.

FIG. 10c illustrates the results of a television user using an acronym associative text input method to input video titles into the search menu of a UI, where that UI is displayed on the television.

FIGS. 11a-11b illustrate the process for inputting a Chinese video title by inputting alphanumeric characters that correspond to a Romanization of the Chinese video title.

FIG. 12 illustrates a channel listing that is displayed on a television for a television user to navigate through to find video titles for playback on the television.

FIG. 13 illustrates a television user using a computer connected to the Internet to remotely manage the content for a television.

FIG. 14 illustrates a television user using a computer connected to the Internet to remotely manage the content for another user's television.

FIG. 15 illustrates television users using various electronic devices to remotely manage the content for a television.

FIG. 16 illustrates a digital picture frame user using a computer to remotely manage the content for a digital picture frame.

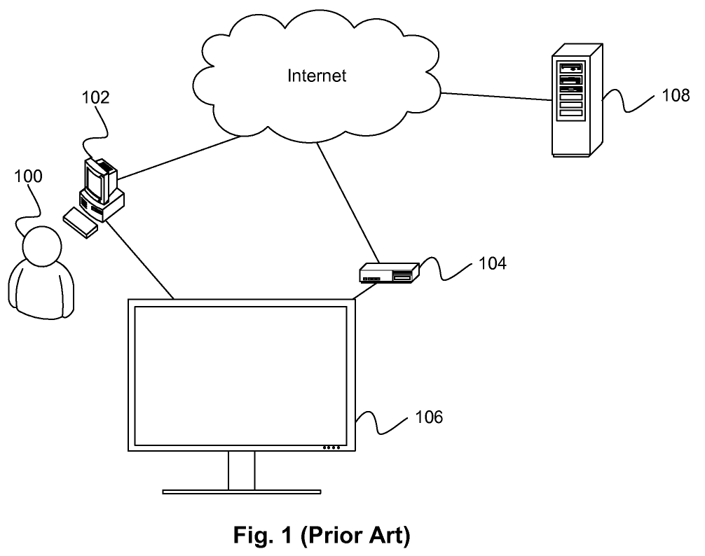

### DETAILED DESCRIPTION OF THE PREFERRED EMBODIMENTS

To aid in the understanding of this invention, the following description of the preferred embodiments will use televisions as examples of CEDs, but in no way should this be construed to limit the invention to televisions. In fact, this invention may be applied to any and all CEDs, including set-top boxes, digital picture frames, monitors, cellular phones, display terminals, and other devices that can display images. In the preferred embodiment of the present invention, each CED can be connectable to one or more networks via optical fibers, ethernet, wireless LAN, home phone lines, or other connection methods. Also, the Internet may be herein used as an example of a network for the purposes of this invention, but this is not meant to limit this invention to the Internet. In fact, this invention may be applied to any network, where a network may be defined as an interconnected group of electronic devices and/or computers.

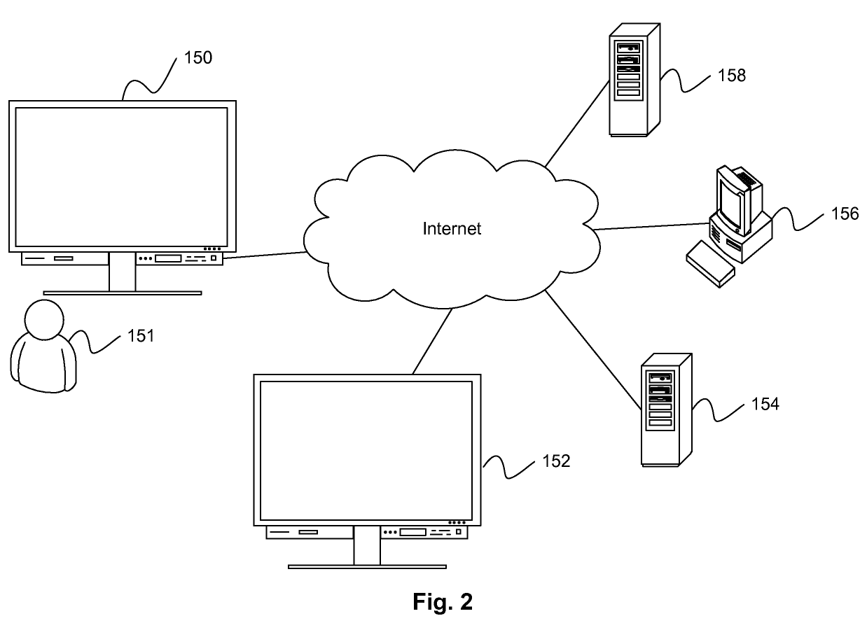

FIG. 2 illustrates the components of an embodiment of this invention for providing content to a television by searching for content on the Internet and downloading that content. Content can be defined as one or more files, wherein the files may be of various file formats including: video formats such as MPEG-1, MPEG-2, MPEG-4, DivX, Xvid, and other video formats; image formats such as JPEG, TIFF, RAW, GIF, BMP, and other image formats; audio formats such as WAV, MP3, WMA, and other audio formats; and other file formats that can be supported for playback or displayed on CEDs. Note that each file of the content can be segmented into a plurality of pieces of data, where those pieces can be further segmented into one or more blocks of data.

Referring to FIG. 2, the components of this system includes a television 150 with the capability to connect to the Internet and to download content from various sources connected to the Internet, such as a television 152, a server 154, a computer 156, and a server 158. The television 150 may support various peer-to-peer software and web browsing software for use in downloading content from various sources connected to the Internet. The television 150 also can contain a user interface providing the television user the capability to input a content request for one or more files for playback on the television. A server can also be built in to the television 150, where that server can be implemented by the television's 150 software and/or by the television's 150 hardware.

The sources from which the television 150 can download from may include, but are not limited to, the following, one or more televisions, one or more servers, one or more computers, and one or more other devices that can connect to the Internet. The television 150 may also support various connections to storage devices for storing downloaded content.

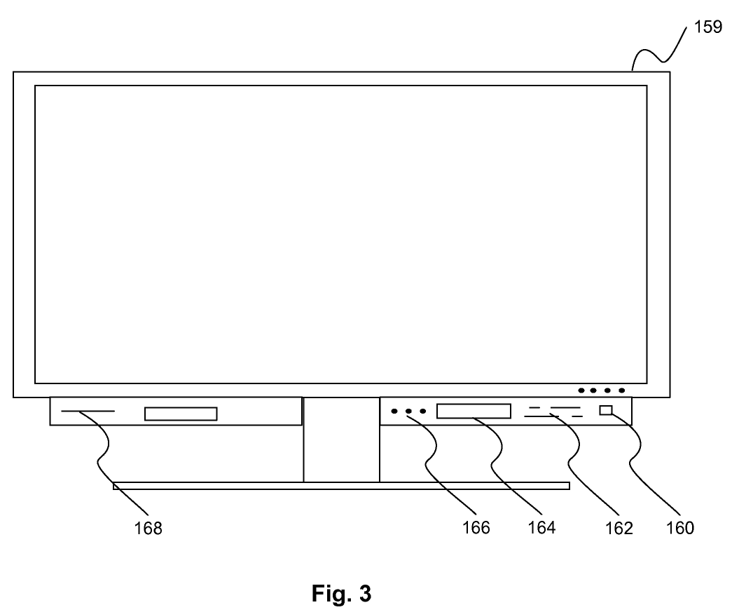

FIG. 3 is an illustration of an example of a television with a variety of connective capabilities and data storage capabilities that can be used for the purposes of this invention. A television's connectivity capabilities may refer to the capability of a television to download content through a variety of technologies, such as through the Internet via a wired broadband connection, a wireless broadband connection, a telephone connection, or a satellite connection, a multimedia card reader, a universal serial bus (“USB”) connection, and other types of connections. A television's data storage capabilities may refer to a television's internal memory or external storage devices that can connect to the television through a multimedia card reader, through a USB connection, or through other types of connections to the television. The hardware implementation and the software implementation to support these connective capabilities and data storage capabilities may be physically integrated, in whole or in part, with the television or may be, in whole or in part, implemented in a physically separate unit that is connected to the television.

The television 159 in FIG. 3 is an example of a television that has the connective capabilities and data storage capabilities physically integrated with the television. Here, the television 159 can support a wired broadband connection 160, flash memory cards 162, storage devices connected through USB connections 164, a wireless broadband connection 166, and storing on and reading data off a CD/DVD writeable drive 168.

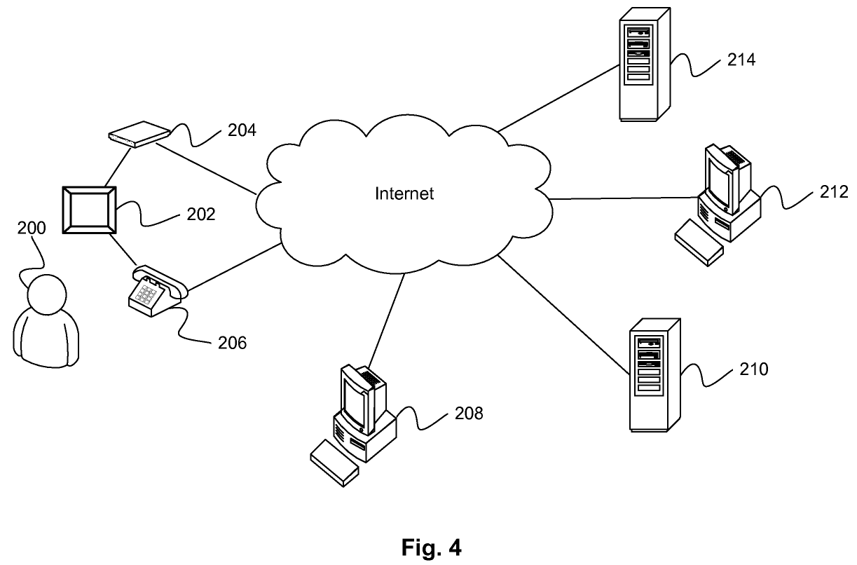

It is emphasized that the methods of this invention may apply to various consumer electronics, including a digital picture frame (“DPF”), set-top boxes, cellular phones and so forth. For instance, FIG. 4 is an illustration of the components of an embodiment of this invention for providing content to a DPF by searching for content and downloading that content via the Internet. Referring to FIG. 4, a DPF 202 can download content from the Internet via a broadband connection 204, via a telephone connection 206, or via other connections. Downloaded content can be downloaded from multiple sources including a computer 208, a server 210, a computer 212, a server 214, and other devices connected either locally to the DPF or devices connected through the Internet.

In the following examples, content requests for video files will be herein used to aid in the understanding of this invention, but in no way is this to limit the invention to content requests for video files. In fact, this invention applies to content requests for various file formats.

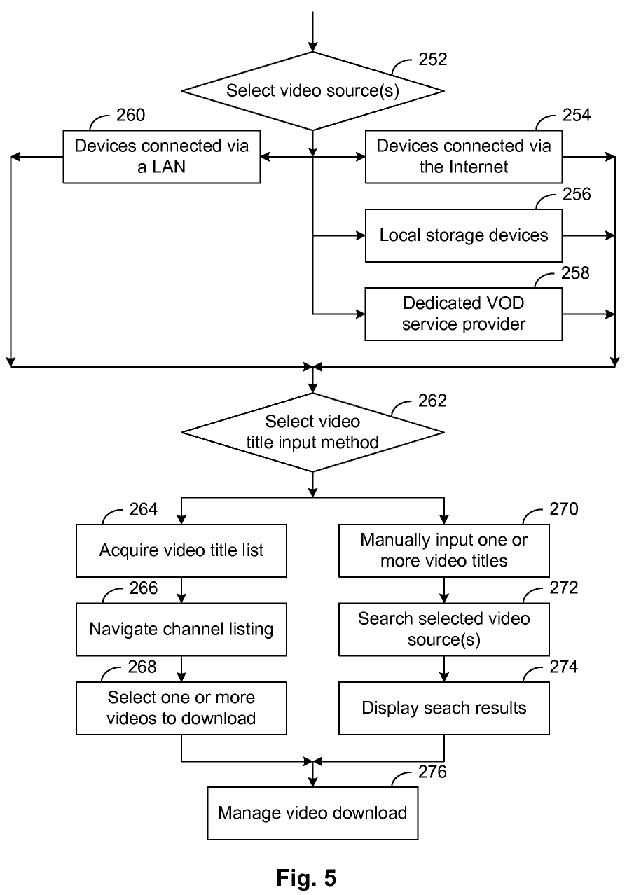

FIG. 5 illustrates a process flow for providing content to a television by selecting video sources from which video files can be located, then searching for requested video files, and finally downloading the found video files for playback on a television. Referring to FIG. 5, video files are searched for in one or more selected video sources 252. These video sources may include devices connected via a local area network (“LAN”) 260, servers, computers, and other devices connected via the Internet 254, local storage devices 256 connected to the television, or a dedicated video on demand (“VOD”) service provider 258. These video sources may be selected by a television user or may be automatically selected by predefined settings.

After the video sources are selected, a television user can then select a method to input video titles 262. The television user can navigate through a channel listing to find video titles for playback on the television. In order to display a channel list of videos and categories of videos, a video title list may be acquired. The video title list can be acquired 264 from a video list server via the Internet or from a locally stored copy of the video title list, wherein the locally stored copy may be updated by the video list server on a regularly set schedule or by the television user manually initiating the update.

In addition to the video names, the video title list can include information about the video titles, information about the associated video for a video title, or links to locations where information about the video titles or associated videos can be found. Examples of such information may include locations from which the video file can be downloaded from, video file size, video category information (e.g. genre type), popularity ranking of the associated video, production date of the associated video, summary of the contents of the associated video, runtime length of the associated video, cast members of the associated video, other video titles that may be recommended based on a particular video title, and any other information related to the video title or the associated video.

Once the video title list is acquired, it can be displayed in a variety of ways such as in alphabetical order of the video titles, by popularity of the associated videos, or by any other indexing means for videos. The television user can navigate 266 through these displays and locate videos by using the user interface. Once the television user has reached a display with video titles, the television user can select one or more video titles to download 268 the associated videos for the one or more selected video titles. After a video title is selected, the video list server may send the television the optimal locations from which the associated videos can be downloaded from. These optimal locations may be in the form of domain names, IP addresses, URL addresses, torrent files for BitTorrent networks, or other resource location identifiers. However, if the television user does not find a particular video title in the video title list, the television user may run a search for that particular video title using a second method for video title input described in more detail below.

Alternatively, a user for the television can make a content request for one or more videos for playback by manually inputting one or more video titles 270. After the video sources have been manually inputted, the video sources are searched for the one or more requested videos 272. If the locations of the one or more requested videos are found by the search, then those locations can be displayed on the television 274 to begin the download process.

The television user can manage the download 276 of the requested videos by selecting download locations. The download locations can also be automatically selected based on the user's preselected preferences or by an optimization algorithm. Once downloading has been initiated, the requested files can be stored in the internal memory of the television or in a variety of storage devices that can be connected to the television.

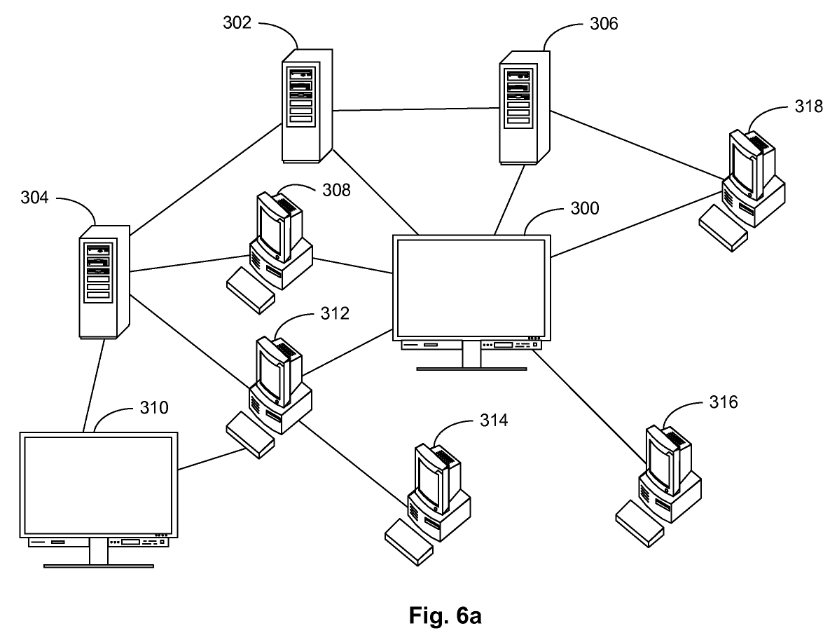

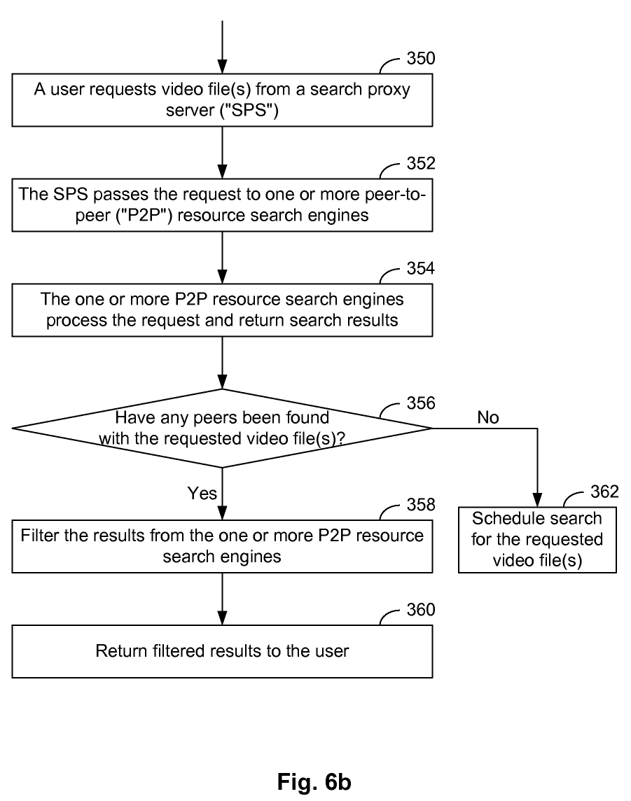

FIG. 6a illustrates the components of an embodiment of this invention, where a television connected to one or more P2P networks can search for user requested content from peers on the P2P networks and download that content. Referring to FIG. 6a, peers, 308, 312, 314, 316, and 318, and televisions, 300 and 310, can be connected via a LAN, via a WAN, such as the Internet, or via any other network of interconnected group of computers and electronic devices. Here, the televisions 300 and 310 can act as peers on various P2P networks since the televisions 300 and 310 support the download of files from peers and the upload of files to peers.

In the P2P networks illustrated in FIG. 6a, a P2P resource search engine server 304 and a P2P resource search engine server 306 keep information on peers and respond to requests for that information. A P2P resource search engine server keeps records of what files, or blocks of files a peer may have, and the location identifier of those peers, such as its IP address, domain name, and other addressing means of the peers.

When the television 300, a peer on the P2P network, herein referred to as a “querying peer,” requests a file to be downloaded, the querying peer queries a search proxy server 302. The search proxy server 302 in turn sends requests to the P2P resource search engine servers, 304 and 306, for locations of peers that have blocks of the requested file. The resource search engine servers, 304 and 306, locate peers that potentially have one or more blocks of the requested file. If such peers are found, the resource search engine servers send the locations of those peers to the search proxy server 302. Note, a search proxy server may be integrated with a querying peer in the same device or it may be a separate device that is remote from the querying peer.

The search proxy server 302 may filter those search results since there may be thousands of locations where the one or more blocks of the requested files can be found. The filtering may be based on the integrity of the data, where that integrity can be a function of the users' ratings of the associated video for that block, the number of previous downloads of that block, or by other means for verifying data integrity. Filtering may also be based on an optimization algorithm, where the algorithm identifies which peers are the most efficient to download from. The filtered results are then passed to the querying peer. The querying peer can then use those locations to initiate the download of one or more blocks of the requested files from the found peers. If one or more files or blocks cannot be located by the resource search engine servers, then the querying peer can schedule a query of the resource search engine servers at a future time for those missing files or blocks.

FIG. 6b is a process flow that illustrates a method for searching user requested files on one or more peer-to-peer networks by searching a plurality of P2P resource search engine servers for the user requested files. Referring to FIG. 6b, the user interface of the television can forward a user's request for one or more files to the search proxy server 350, wherein the search proxy server can pass the user's request to a plurality of P2P resource search engine servers 352.

The one or more P2P resource search engines process the request and return the search results 354. If peers have been located with the requested video files 356, the search proxy server (“SPS”) filters the search results 358 based on the integrity of data, as discussed above, and based on an optimization algorithm. The filtered results are then passed to the user 360, where the filtered results may contain locations such as a domain name, an IP address, or other location identifiers as to where one or more blocks of the requested files can be found. If no locations have been found, a search for the requested files that have not been found can be scheduled 362 in the future.

If the locations have been found, then an optimization algorithm is used to find the most efficient locations to download from. The optimization algorithm takes into consideration the upload speed for the found locations, download speed for the television, physical distance between the peer and the television, which blocks of a requested file are available by the peer, the download order of the requested files, network traffic, and other network related considerations. The file can then be downloaded according to the optimization algorithm. The optimization algorithm can be periodically calculated and be applied during the downloading process since the optimization algorithm considerations can constantly change as the downloading progresses.

After the blocks from the found locations have been downloaded, the downloaded blocks are used to check whether the requested files are complete copies. If the requested files are not complete, then a future search can be scheduled for the missing blocks.

### BT Optimization Algorithm

Generally for a BitTorrent (“BT”) P2P network, a BT client, also referred to as a querying peer, searches for a requested video by searching the Internet or other networks for the associated torrent file for that requested video. Once found, the associated torrent file is downloaded. The downloaded torrent file identifies one or more trackers, which are servers that aid in finding peers who have pieces of the requested file and blocks of the requested file.

The BT client connects to the trackers specified in the torrent file, from which the BT client requests peers that may have blocks of the requested file. The client connects to those peers to download various blocks of the requested file. Since the availability of peers and network conditions are rarely static, a download strategy can be employed to optimize the time and resources used for downloading the requested file.

Such a strategy can be developed by dynamically searching for peers who possess one or more blocks of the requested file and by managing the download of the requested file. First, a BT client reserves a memory space for downloading the requested file. After the BT client requests one or more available peers with one or more blocks of the requested file, the available peers can be stored in the memory space, where those peers can be identified by nicknames, IP addresses, domain names, URL addresses, other computer addressing means, or other unique identifiers of the received peers.

The blocks from the available peers may not be sufficient to download a complete copy of the requested file since some blocks of the requested file may not be provided for by the available peers. Also, the BT client may not be able to connect to some peers due to unavailability of those peers or due to network conditions. For these reasons, the BT client may need to schedule an update of the available peers from the trackers to find missing blocks.

A plurality of queues can be generated for managing the download for the requested file and for adjusting a rate for requesting peers from the trackers. Within each queue, the peers can be identified by nicknames, IP addresses, domain names, URL addresses, other computer addressing means, or other unique identifiers of the respective peers. The queues can be structured in various data structure formats. For instance, the first peer placed in a queue can be the first peer taken out, referred to as a first-in first-out (“FIFO”) queue. A queue can also be structured such that the last peer placed in the queue is the first peer taken out, referred to as a last-in first-out (“LIFO”) queue. Also, a queue may have no internal structure whatsoever, and may be merely a collection of peers. These examples illustrate a few of the many different types of queues that can be used for this invention.

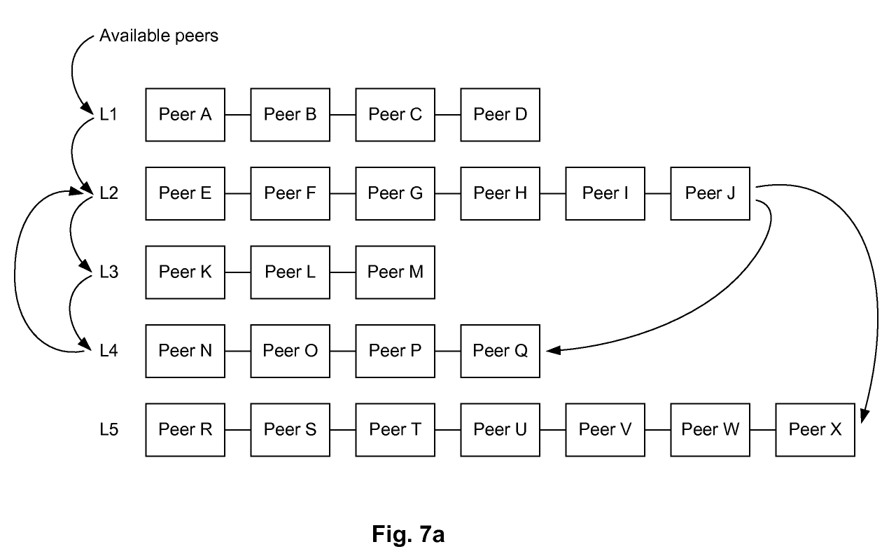

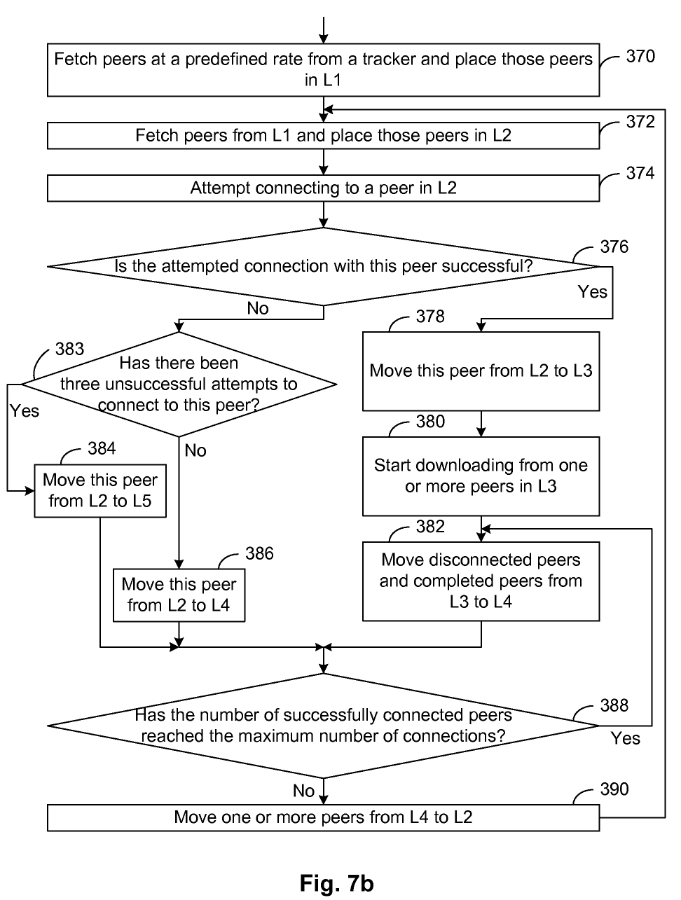

FIG. 7a illustrates a preferred embodiment of the present invention having five queues used for managing the download for a requested file. A first queue, herein referred to as L1, may contain peers received from the trackers, where these peers that are received from the trackers can be referred to as available peers.

A second queue, herein referred to as L2, may contain peers that the BT client is currently attempting to connect to. These peers may be referred to as trying-to-connect peers. Since most CED's are of limited resources, the number of connections to peers may be limited to a maximum number. The maximum number of connections may be heavily dependent on the amount of resources available to the CED. On the one hand, a home computer may be able to support hundreds to thousands of connections without severe degradation in system performance. On the other hand, a DPF, which may be more limited in terms of resources, may support up to a maximum of 60 connections at any one time. Therefore, L2 may be set to the desired length depending on the resources and capability of the associated CED.

If the maximum number of connections supported by the CED has not been reached, then L2 may attempt to add more peers from L1 to establish additional connections.

A third queue, herein referred to as L3, may contain peers that the BT client is currently connected. Peers in this queue can be referred to as the currently-connected peers. For these successfully connected peers, the BT client can begin downloading from these currently-connected peers or uploading to these currently-connected peers. Since current connections to peers may end abruptly, e.g. by a randomly dropped connection, or naturally, e.g. when downloading from a peer is complete, the number of peers contained in this queue may be constantly changing during the download of the requested file.

A fourth queue, herein referred to as L4, may contain peers that are not currently connected to the BT client, but may have been previously connected with the BT client. Peers in this queue can be referred to as previously-connected peers. For instance, peers that the BT client has finished downloading from or finished uploading to can be referred to as previously-connected peers. Additionally, peers that the BT client has unsuccessfully attempted to connect to may also be in this fourth queue.

A fifth queue, herein referred to as L5, may contain peers that have not successfully connected to the BT client. Peers in this queue can be referred to as failed peers. For instance, peers that cannot be successfully connected to after three attempts may be placed in L5.

Once the queues have been generated, certain conditions can be set to select which peers to download from, the order of which peer to download from, and the rate at which to request more peers from the trackers.

FIG. 7b illustrates a process flow for utilizing the generated queues in downloading from the received peers. Referring to FIG. 7b, L1 fetches 370 for peers from a tracker at a predefined rate, and places those peers in L1. L2 fetches 372 for available peers in L1, and places those available peers in L2. The BT client attempts to connect 374 to a peer (or a plurality of peers) in L2. Next, the BT client checks whether the attempted connection with that peer in L2 has been successful 376. If the peer has successfully connected to the BT client, then that peer can be moved 378 from L2, and placed in L3.

If the BT client cannot connect to that peer, it is then determined whether there have been three unsuccessful attempts to connect to that peer 383. If that peer has three unsuccessful connection attempts, then that peer can be moved to L5 384. If that peer does not have three unsuccessful connection attempts, that peer can be moved to L4 386.

The BT client downloads 380 from the currently-connected peers in L3. Once the BT client has completed downloading blocks from a peer in L3 (referred to as a “completed peer”), that peer can be moved to L4 382. The peers in L3 that have been disconnected can also be placed in L4 382. If the number of currently-connected peers has not reach the maximum number of connections 388, one or more peers in L4 can be moved to L2 390 (more peers can be fetched from trackers and placed in L1). Next, the BT client can attempt to connect to a peer (or a plurality of peers) in L2 372. However, if a first pre-defined maximum number of connections has been reached, then move disconnected peers from L3 to L4 382, and move completed peers from L3 to L4.

If the total number of peers in L1 through L5 is less than a second pre-defined maximum number of peers, then the BT client can increase the rate for requesting additional peers. Alternatively, when the maximum number of peers has been reached, the rate for requesting peers from the tracker can be decreased. The maximum number of possible peers can be defined based on the amount of memory of a respective CED and the maximum number of connections for that CED.

For instance, the rate for requesting peers may be initialized to one request for peers from the trackers every minute, e.g. rate=1/1. If the maximum number of peers has been reached, then the rate for requesting peers from the trackers can be decreased to one request every two minutes, e.g. rate=½, and can be further decreased by an additional minute, where the minimum rate would be one request every ten minutes, e.g. rate= 1/10.

If the maximum number of connections has not been reached, then the rate for requesting peers from the trackers can be increased by one minute, with a maximum rate for one request every minute. For instance, if the request rate is at one request every three minutes, e.g. rate=⅓, then it is increased to one request every two minutes, e.g. rate=½. The request rate may be modified after each request from the trackers or may be updated at periodic intervals.

The rate for requesting peers can also be subject to a “health” value for each of the available peers received from the trackers. The health value can correspond to the percentage of the requested file that can be downloaded from the received peers. The health value can also refer to the percentage of the remaining blocks or the number of the remaining blocks needed for a complete file that can be downloaded from a peer. For instance, if 95 percent of a total file can be downloaded from a peer, then a “very healthy” value of 95 may be given to that peer. Depending on the health values and the number of peers in L1 through L5, the rate for requesting the peers list from the trackers can be initially set and modified.

In addition, individual peers may be regularly tested for the quality of that peer. The quality of a peer (or a quality value) may be determined based on: (1) the download speed from that peer; (2) the amount of data downloaded from the peer; (4) the amount of time that the BT client has been connected to that peer; (5) health value of that peer; (6) downloading error rate; (7) relative standing to other peers in terms of download speed, amount of data downloaded, and other relative comparisons; and (8) other considerations that may effect the transmission speed of the peer to the BT client.

If a peer is connected to the BT client and is found to be of low quality, then that peer is shutdown and jammed, wherein shutdown can mean disconnecting from that peer and jammed can mean blocking that peer from connecting to the BT client. For instance, if the number of peers in L2 and L3 has reached the maximum number of connections, then the low quality peers can be shutdown (e.g. disconnected) to allow the BT client to connect to higher quality peers. In this way, overall download performance can be improved since only higher quality peers are used for downloading blocks of the requested file.

When uploading to peers on the BT network, the optimization algorithm may decide which peers to upload to and the order of uploading, or may randomly select a peer from L3. For instance, peers that have blocks of a requested file that are needed to complete the download of the requested file should not be jammed since under many P2P protocols the BT client can gain preferential status from those peers it uploads to. The BT client's preferential status may lead to various benefits for the BT client such as increased download speed from these peers or higher downloading priority by these peers.

If the maximum number of connections has been met, then determine whether the peers being connected to have data that the BT client needs. If the peer does not have data needed by the BT client, the BT client should disconnect from that peer, and then jam that peer. If a peer has blocks that are needed by the BT client and if that peer requests blocks from the BT client, then the BT client should not disconnect from that peer, or jam that peer. If the BT client uploads to more than one peer, then the BT client can upload to those peers one at a time by rotating through those peers or by splitting the upload bandwidth amongst a plurality of peers. By uploading to peers that may have blocks needed by the BT client, the BT client can gain preferential status from those peers.

In one embodiment of this invention, a DPF can limit the number of uploads to 8 peers. One or two peers can be randomly selected from all possible peers; and the other six or seven peers can be randomly selected from a subset of the peers in L3, where that subset comprises of peers in L3 that have previously uploaded data to the BT client. Furthermore, each piece of a requested file can be segmented into 16 equal blocks. The DPF can request 4 blocks at a time from each peer. If the connection is disconnected before all four blocks have been received, the DPF can request the missing blocks from other peers on the BT network.

Since writing data to the BT client's hard drive and reading data from the BT client's hard drive can be time consuming due to slow read times and slow write times, a buffer is used to store a small amount of data in fast memory with relatively faster read times and faster write times. This buffering technique may be optional since some CED's may not have a traditional hard drive or various types of memories.

A buffer can be 2 MB for downloading blocks from peers or other sources. When the buffer is at a maximum threshold, for instance at 95 percent full, then the entire buffer is written to the hard drive or other memory means. If not, the downloaded data is continually stored in the buffer until the buffer reaches or exceeds the maximum threshold. The maximum threshold can be defined at any percentage of the buffer wherein efficiency is gained when compared to continually writing downloaded blocks to the hard drive.

When a BT client uploads to one or more peers, a buffer may be generated to store 2 MB of data for uploading to peers or other destinations. When the buffer has yet to reach the maximum threshold, the next chunk of data is written to the buffer from the hard drive or other memory means. For instance, when a peer requests blocks from the BT client, the BT client searches the buffer for the requested blocks. If the one or more requested blocks are contained in the buffer, then the one or more blocks are uploaded to the peer. If not, the BT client can directly upload it from the hard drive or by first placing the blocks in the buffer and then uploading the blocks from the buffer.

Although this buffering strategy is explained according to the BT protocol and BT networks, these methods can apply equally to P2P networks and other networks, for instance the Internet or LANs.

### Input Methods

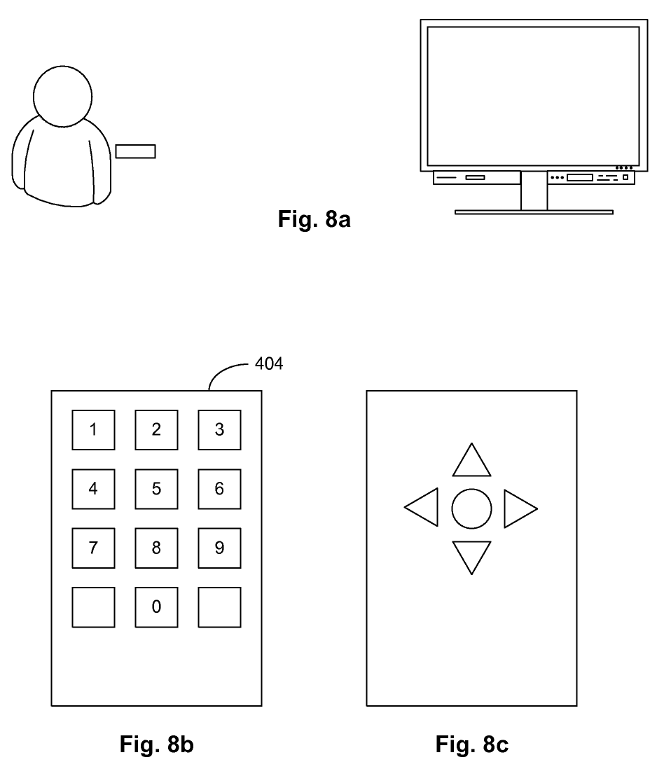

To request one or more files to playback on a television, a television user can input commands to the television's user interface software by using a television remote control, onscreen touch buttons, or television buttons. FIG. 8a illustrates a television remote control that can be used to input commands to the television's user interface. FIGS. 8b and 8c illustrate two examples of the many types of television remote control configurations that can be used to input commands for the purposes of this invention.

A television user can request a video to playback on the user's television by inputting the video title to the television's user interface by using the television's remote control. Through a defined mapping of alphanumeric characters to one or more buttons on the television remote control, the television remote control can be used to input video titles. Examples of such mappings can be where one alphanumeric character is mapped to one television remote button or where a group of alphanumeric characters are mapped to one television remote button.

Referring to FIG. 8b, for television remote 404, there cannot be a one to one mapping of one television remote button to only one alphanumeric character since there are fewer television remote buttons than alphanumeric characters. Television remote 404 has a total of 12 buttons. For a one to one correspondence of television remote buttons to alphanumeric characters, there needs to be at least 36 buttons since there are 36 alphanumeric characters (26 English letters plus 10 numeric digits equals 36 alphanumeric characters). Instead, the mapping may be defined such that multiple characters can be mapped to one button on the remote control. Multiple characters mapped to the same button can be distinguished from each other by the number of times that button is pressed consecutively. This method will be herein referred to as the multitap text input method.

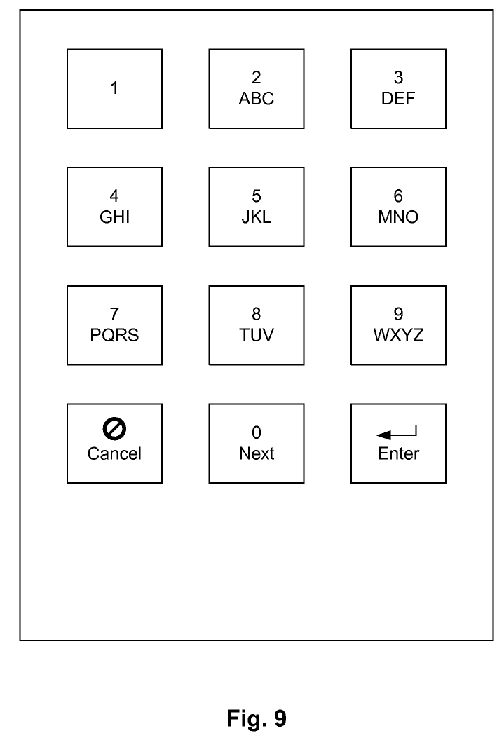

FIG. 9 illustrates a typical television remote control, where the numbered buttons of the television remote control can be mapped to multiple English letters. Referring to FIG. 9, the number button representing the digit 2 is mapped to the characters A, B, and C; the number button representing the digit 3 is mapped to the characters D, E, and F; the number button representing the digit 4 is mapped to the characters G, H, and I; the number button representing the digit 5 is mapped to the characters J, K, and L; the number button representing the digit 6 is mapped to the characters M, N, and O; the number button representing the digit 7 is mapped to the characters P, Q, R, and S; the number button representing the digit 8 is mapped to the characters T, U, and V; and the number button representing the digit 9 is mapped to the characters W, X, Y, and Z.

In FIG. 9, the multitap text input method can be used to distinguish different letters mapped to the same button by the number of times a button is pressed. For instance, the television user may only want to choose one of the three letters mapped to the button representing the number 2. This can be done by pressing number 2 once to get A, consecutively pressing number 2 twice to get B, consecutively pressing number 2 three times to get C, or consecutively pressing number 2 repeatedly to toggle between A, B, and C.

Referring to FIG. 9, numeric digits can be inputted using the remote control by pressing the corresponding numbered buttons. A button not used, such as the cancel button, can be mapped to the remote control for toggling between the numeric inputs and character inputs. Toggling between the numeric inputs and the character inputs enables a television user the capability to input the 36 alphanumeric characters with only 10 buttons on the remote control. In order to input symbols, another toggle may be necessary to access a mapping of symbols to the remote control buttons. Although the remote control herein described uses a mapping of alphanumeric characters and symbols to 10 buttons, the multitap text input method can be used for any number of buttons and mappings.

In order to select the next character, the remote control user can press a “next” button (in FIG. 9, the button representing “next” is the numeric digit 0) to select the next letter for input in the desired word or phrase. A phrase can mean one or more words, where each word can be one or more alphanumeric characters. The next button can also be used to input spaces, such that the space can be used to signify an end to an inputted word or to input more words. This next feature may also be triggered by a defined delay in time between consecutive button presses.

Additionally to the multitap text input method, a predictive text input method can be used to reduce the number of button presses needed to input a specific alphanumeric phrase or word. Instead of pressing the same button multiple times to switch between several characters mapped to a single button and then inputting the next letter in the word or phrase by following the same multitap process, the predictive text method generates possible word and phrase completions based on only one press of a button for a group of characters mapped to that button. All combinations of the group of characters corresponding to the sequence of button presses are looked up in a word database. The combinations of characters that are found to be words in the database can be listed in order of the most frequently used word first, followed by the second most frequently used word, and so on.

For instance, referring to FIG. 9, if button 4 and then button 3 are pressed, the permutations made by G, H, and I as the first letter with D, E, and F as the second letter are looked up in the dictionary. Those permutations are “gd,” “ge,” “gf,” “hd,” “he,” “hf,” “id,” “ie,” and “if.” The words that are found in the dictionary using the different permutations can then be listed in order of frequency of usage or by other indexing schemes. A frequency of usage for words can be found through generally available statistical analysis on this subject. Here, “he” may be the first word, followed by “if,” “gear,” “head,” and so forth, until a defined maximum number of words found in the dictionary have been listed.

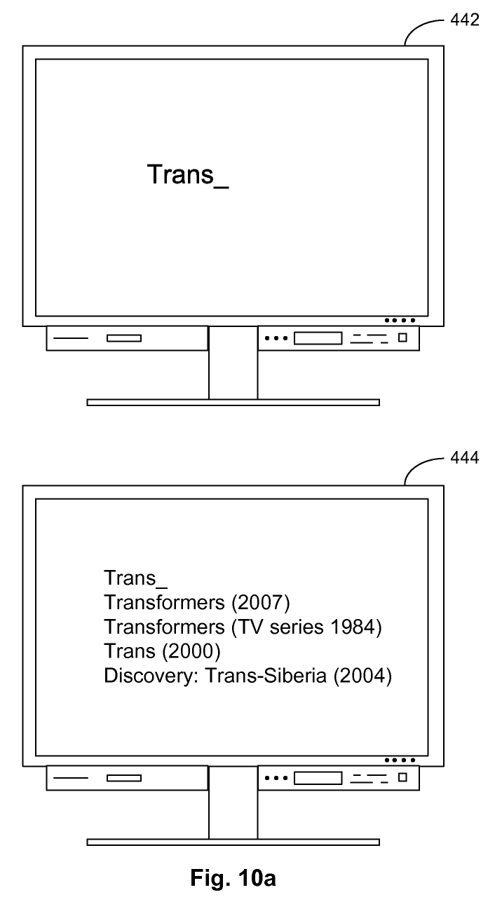

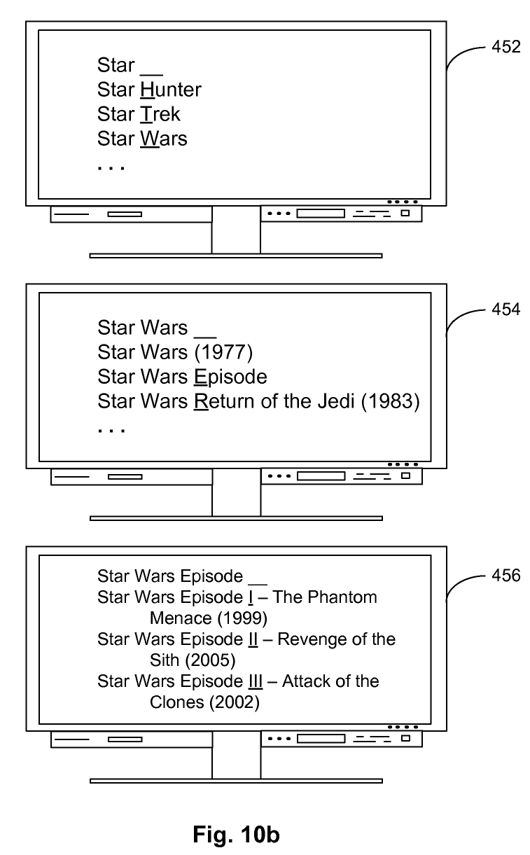

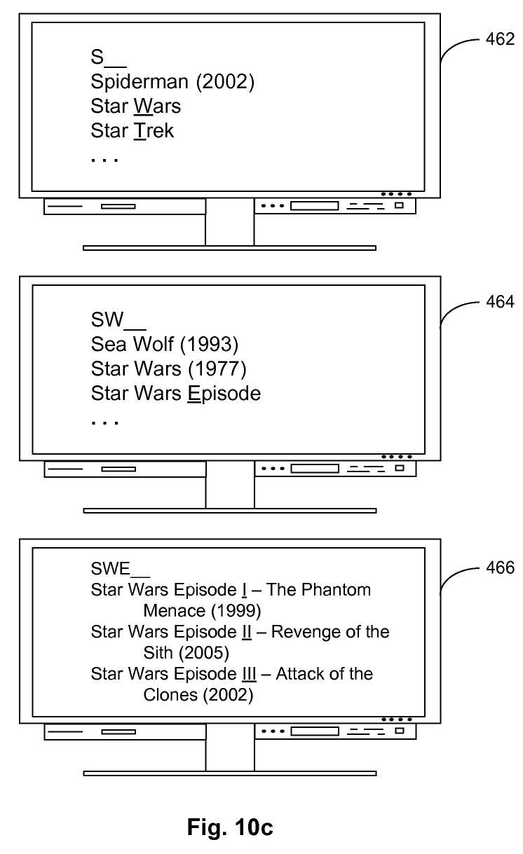

FIG. 10a is an illustration of the results of displaying a television user's input, where the predictive text input method is employed by the television user to input a video title. Referring to FIG. 10a, a television user can input the characters to a television 442 using the predictive text input method. The television 444 is an illustration of a television screen displaying the mostly likely completion for the inputted characters. Referring to the television 444, the dictionary used for the predictive text input method can be a list of video titles, similar to the video title list provided for in FIG. 5, 274. Furthermore, the video titles may be listed in order of popularity of each video title, where that popularity can be measured by users' ratings for the listed videos, money earned by the listed videos, production date of the listed videos, or by any other indexing scheme for videos.

FIG. 10b is an illustration of another manual input method, herein referred to as the associative text input method. In the associative text input method, the first word is inputted in the same manner as the predictive text input method. However, the following words in the requested video title can be inputted by only inputting the first letter for the next word in the video title, instead of inputting all the characters in the next word. Based upon the previous words in the inputted video title, the next word can be predicted by the first letter inputted in for the next word. The most likely video title completion is returned and displayed to the user to avoid multiple button presses for each character in each word of the video title.

For example, referring to FIG. 10b, television 452 displays the results of a user inputting the first word “Star” to a television using the predictive text input method. The inputted word “Star” will be used to lookup the video title list for matching video title completions. The possible matching completions are listed for the user to select one if the user so chooses. At this point, this is similar to the predictive text input method, however, the following words inputted by the user can now be inputted by simply inputting the first letter of each succeeding words in the video title. For instance in television 454, the next word “Wars” is automatically selected after the user has inputted “w.” This differs from the predictive text method since in the predictive text method there would be at least four button presses, one for each letter in the word; whereas here, only one button, the button representing “w,” is used. The associative text input method can potentially save on the number of button presses, and ultimately time.

The next words can be selected in the similar manner by simply pressing the first letter of the next word. Television 456 displays the results of the next word “Episode” by the user inputting “e.” If there is only one possible video title, then that video title can be automatically chosen to save the user time from having to input more characters. However, if that chosen video title is not the video title that the user wants, the user can continue inputting characters using the predictive text input method.

FIG. 10c illustrates another method for manually inputting a video title, herein referred to as acronym associative text input method. In the acronym associative text input method, a user can simply input the initials of a video title to search for it in the video title list by matching the video titles that match the inputted initials. For instance, referring to FIG. 10c, if a television user wants to request the video Star Wars Episode I, the user can input “SWEI” to select the Star Wars Episode I video. To better illustrate this method, the first few steps will be given. In television 462, the results of the user typing in the first letter S can be displayed on the television screen along with possible video title completions. In television 464, the results of the user typing in the second letter W is displayed on the television screen along with possible video title completions. Furthermore, in television 466, the results of the user typing in the third letter E is displayed on the television screen along with possible video title completions. With this method, the possible video titles are narrowed down while only using a minimum number of button presses to input a video title.

Different permutations of the various combinations of the multitap text input method, the predictive text input method, the associative text input method, and the acronym associative text input method can be implemented. The user also has the option to customize their input method as one of the stated input methods or a combination of them.

Additionally, the multitap text input method, the predictive text method, the associative text method, and the acronym associative text input method can be extended to support multiple languages that can be represented using the English alphabet. For instance, the pinyin system is the most common standard for representing simplified Chinese using the English alphabet. A predictive text input method can be used for this pinyin system by using a pinyin dictionary to retrieve commonly used Chinese words matching the inputted English characters.

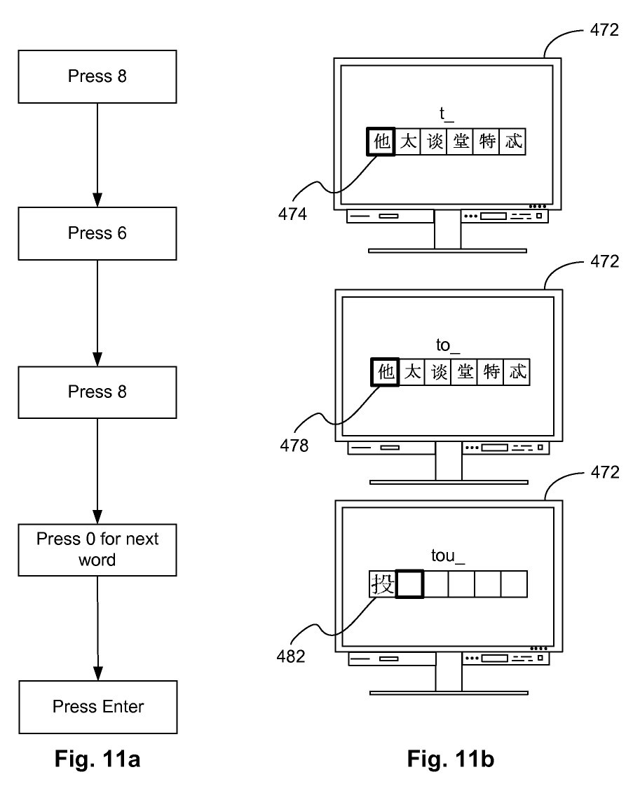

FIG. 11a illustrates the process flow for inputting a pinyin word or phrase using the predictive text input method. FIG. 11b illustrates the associated display for the sequence of buttons pressed in FIG. 11a based on the alphanumeric mapping of a television remote control illustrated in FIG. 9. Referring to FIG. 11b, when the user presses 8, the letter “t” is displayed on the television 472. A drop down menu 474 with six possible Chinese word matches based on the pinyin system can be displayed below the input. The possible Chinese word matches can be displayed in the pinyin system or in the Chinese character system. The drop down menu 474 displays six possible Chinese character matches.

As the user continues inputting several consecutive letters, the predictive text input method can update the list of possible word matches based upon the inputted letters. For instance, when “o” is inputted and displayed on the television 472, an updated list 478 of possible word matches can be displayed based on the current input “to”.

If the desired word is found, then the user may select that word. The user can select a word in the possible word match list 478 by highlighting the particular box that contains the desired word. If the desired word has not been found, the user can continue inputting characters until the desired word is found or until the input of the desired word is finished.

If the user needs to input additional words, additional words may be inputted in the same manner. For instance, the user may continue inputting characters by inputting the next character “u.” An updated list of possible word matches 482 can be displayed based upon the inputted letters “tou.” The predictive text input method can continue in this way for pinyin words until the desired word is found or has been inputted. Similarly other foreign languages can be supported by the multitap text input method, the associative text input method, and the acronym associative text input method.

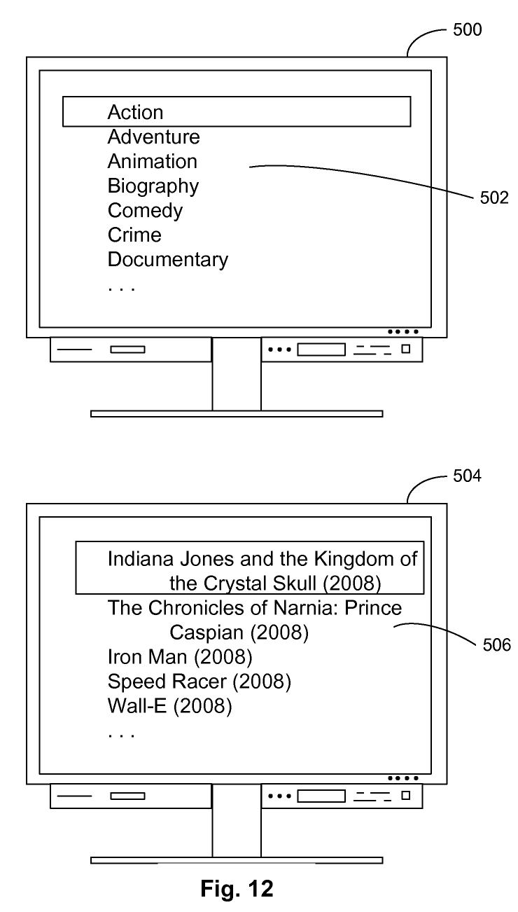

In addition to inputting video titles, a television user may also use a television remote control to navigate through a channel list to find a particular video title. FIG. 12 illustrates the results of navigating through a search menu that is displayed on a television screen. The television user can navigate the menu to select video titles to request the associated video for playback on the television. Referring to FIG. 12, a television user can search through an index of videos that have been organized into various categories and subcategories. The television 500 illustrates a main category menu 502, where that main category 502 consists of video genre types listed in alphabetical order. The user can select a genre by highlighting the desired genre and pressing “enter” on the television remote control to display the subcategories within that genre or the video title list within that genre.

Within each genre, another index may be displayed where the television user can navigate through in a similar manner, until a menu with a list of video titles 506 is finally displayed on television 504. The list of video titles within each genre and subcategories can be ordered in various ways, such as by alphabetical order, in ranking of popularity, by production date, randomly, or by any other indexing method. Once a video title list has been reached through the search menu, the television user can select a video title for playback on the television. The television user can do this by using the television remote control to highlight the desired video title and pressing enter on the television remote control to select the highlighted video title.

A television user is not limited to using the television remote to input commands to the television's user interface. A television user can use onscreen touch buttons, buttons, buttons physically attached to the television, or devices that can connect to the television through the television's many connective capabilities.

### Remote Management of CEDs

In another embodiment of the present invention, a television user can also remotely manage the content for a television or other CEDs. In the previously discussed input methods, a television user inputted commands and video titles to the user interface of a television based on the display of the user interface on that television. In remote management, the user may remotely program the content for a television from a remote location via a network, where that programming may entail inputting a video title or inputting other commands.

Once a user has connected to the network, e.g. the Internet, a LAN, or other networks, using a network enabled device, the user can remotely manage a television in several ways. In one way, the user may directly login to the television via the network and program the television in a similar manner as if the user was physically in front of the television viewing the menu options on the television. Instead of displaying the interactive menu on the television, the interactive menu can be displayed on the device used to remotely manage the television.

Additionally, a television user may login to a remote management server, where that remote management server may keep a record of the requested videos, videos that have been downloaded, the television's serial number, the network location of the television, such as the IP address, the domain name, the URL, or other addressing means, and other information. The remote management server can also be built in to the television 150, where the remote management server can be implemented by the television's 150 software and/or by the television's 150 hardware.

The television's serial number may be any number assigned to a television that uniquely identifies that television from other televisions. To login to the remote management server, the television user may need to identify the television by either providing the television's serial number, network location of the television, or password (where that password can be defined by the user to login to the remote management server).

Once a television user has logged in to the remote management server, the television user can: (1) schedule the deletion of videos from internal and external storage devices; (2) make requests of videos for playback; (3) make content requests for one or more files; (4) delete requests for videos; (5) cease current downloads of one or more blocks of requested video files; (6) schedule future searches for one or more blocks of requested files; and (7) manage other aspects of the television.

The remote management server can relay the user selected commands to the television by: (1) logging in to the television and relaying those commands; or (2) waiting until the television has connected with the remote management server, and then relaying the commands. If a content request is relayed to the television, the television can search and download content as previously discussed. Alternatively, the remote management server may handle the content request by searching for the content and downloading that content. Once the television and the remote management server are connected, the remote management server can stream that content or upload that content to the television.

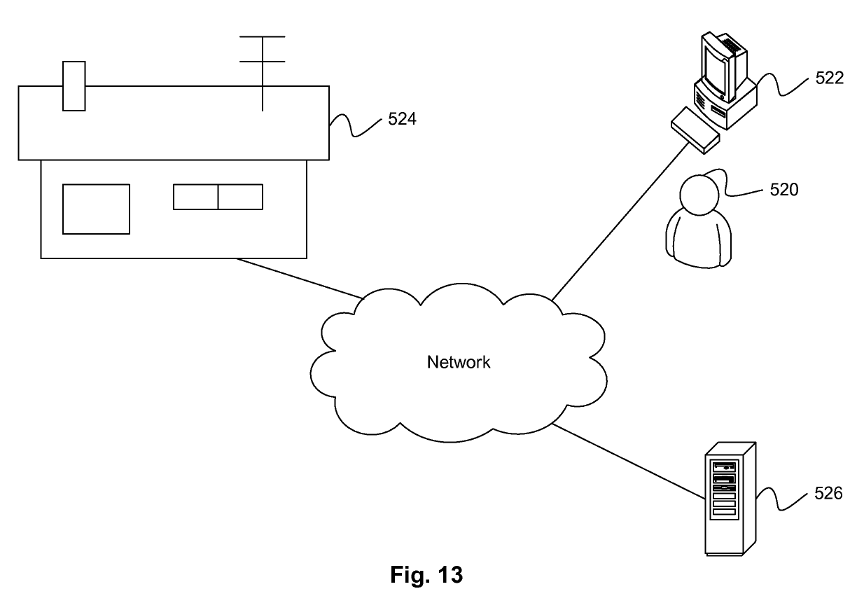

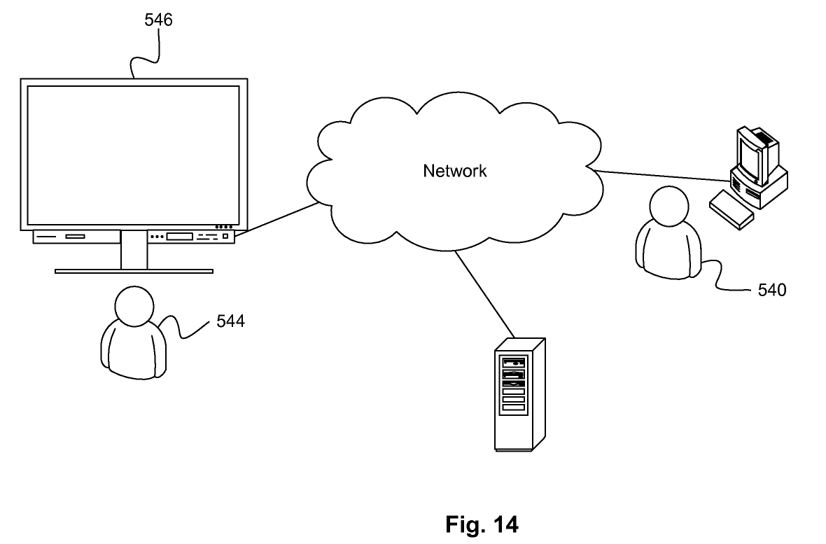

FIG. 13 illustrates a television user managing the user's television from a remote location. Referring to FIG. 13, a television user 520 can request a video for playback on the user's television located at the user's home 524 from a remote location. The user can use a computer 522 to login to a remote management server 526 for that television. The remote management server 526 provides the remote user 520 the functionality to make requests for the playback of videos, to schedule the deletion of downloaded videos, to delete requests for videos, to manage the download of requested videos, and to manage other aspects of the television.

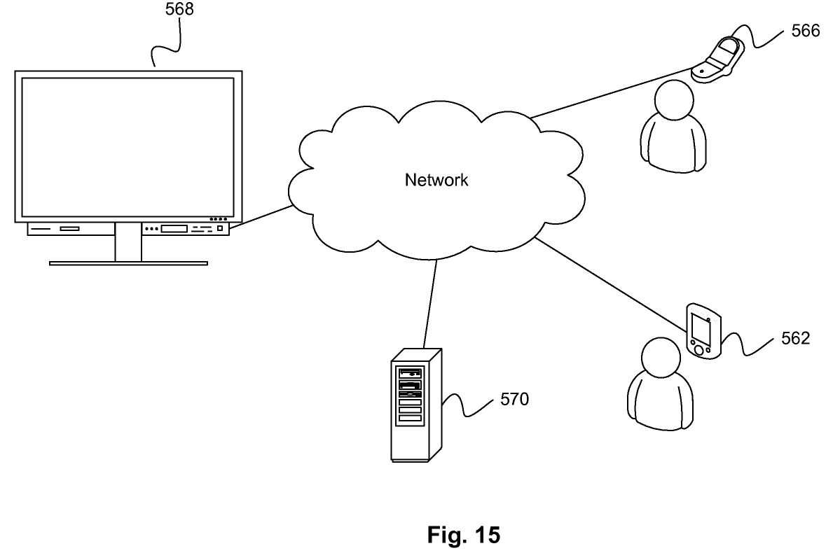

FIG. 14 is an illustration of a television user using a computer connected to the network to remotely manage the content of another user's television by logging into the television or by logging in to a remote management server. Referring to FIG. 14, remote management may not necessarily mean the management of a user's own television, but can also mean the remote management of another user's television 546. For instance, user 544 may be the grandmother of user 540, where the grandchild, user 540, can assist his/her grandmother, user 544, by programming videos for playback on television 546. In this way, the grandmother does not have to learn or know how to program a video for playback on the grandmother's television. This makes it much more convenient for the grandchild since the grandchild does not have to be physically at his/her grandmother's house to program the television.

Another benefit of remote management is that one user can control the video content of another user's television. For instance, a mother can control the content that her child has access to. The mother may only want the child to view child specific video content. Thus, the mother can select children specific programming for that child's television.

Additionally, remote management can be especially beneficial for television users who do not know how to provide content to their television over the network. For instance, if a television user's grandmother enjoys watching old movies from the 1940's, but does not know how to get such content to view, a television user can use the network to find such video content and program the grandmother's television with that content.

Not only can the resources of the network, e.g. the Internet, be available to a larger number of people, but remote management can also add convenience for any television user by giving the television user the option to program a television from any location and time, such as at work, in the user's car, during a lunch break, and so forth. For instance, the television user can use remote management to search for content and to start downloading that content while the television user is at work. Since many video files are 500 megabytes (“mb”) or larger, it can take many hours to download the video files with a standard DSL broadband connection download speed of 1.5 mb/second. Since there can be ample time for the requested video files to be downloaded while the television user is at work, when the television user returns home, the video files will be ready to be played back.

FIG. 15 is an illustration of multiple television users using various electronic devices to remotely manage the content of their television. Referring to FIG. 15, remote management can be accomplished through a variety of devices that can connect to the network. To list a few examples, a user may use a network enabled cellular phone 566, a network enabled a personal digital assistant (“pda”) 562, or other devices that can connect to the network. Once these devices connect to the network, then the devices can remotely manage a television 568 by logging in to the television 568 or by connecting to a remote management server 570.

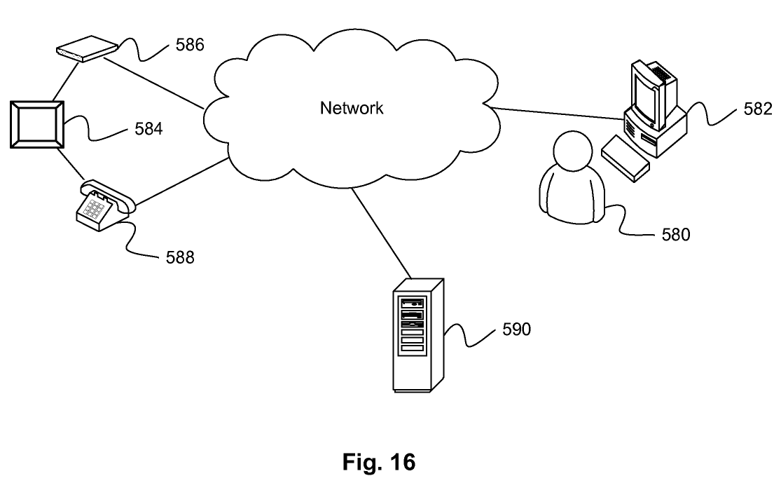

Additionally, remote management may also work for other CED devices, such as DPFs. FIG. 16 is an illustration of a DPF user using a computer connected to the network to remotely manage the content of the user's DPF. Referring to FIG. 16, the methods for remote management of a television can be used for the remote management of a DPF 584. A user 580 can use a device, such as computer 582, to login to the DPF 584 through the network via a broadband connection 586 or via a telephone connection 588 to remotely manage the DPF 584. Alternatively, the user 580 may login to a remote management server 590 to remotely manage the DPF 584.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for managing content for a consumer electronic device (“CED”) via one or more networks, wherein said CED being uniquely identifiable, comprising the steps of:
providing a server, wherein said server being connectable to said CED;
connecting remotely by a user device to said server via said networks;
providing by said user device to said server a content request for said CED, wherein said content request requesting a content and the content being located at one or more locations;
requesting by said server for the locations of the content;
providing by said server to said CED the locations of the content; and
fetching the content by said CED from the locations of the content.

2. The method of claim 1 wherein said server is integrated with said CED.

3. The method of claim 1 wherein said CED is a television.

4. The method of claim 1 wherein said user device is a remote computer.

5. The method of claim 1 wherein said user device is a mobile phone.

6. The method of claim 1 wherein in the providing by said user device step, a user inputs said content request to a user interface displayed on said user device, where said user interface relays said content request to said server.

7. The method of claim 1 wherein in the providing by said user device step, a remote control for said CED is provided and a user inputs said content request through said remote control, where one or more alphanumeric characters are mapped to one or more buttons on said remote control.

8. The method of claim 7 wherein in the providing by said user device step, one or more possible phrase completions associated with the inputted content request is generated based on a sequence of button presses on said remote control by said user.

9. The method of claim 8 wherein in the providing by said user device step, said possible phrase completions are alphanumeric representations for non-English phrases.

10. The method of claim 1 wherein in the providing by said server step, said locations are filtered based on the integrity of one or more blocks of said content and based on the quality of said locations.

11. A method for managing content for a consumer electronic device (“CED”) via one or more networks, wherein said CED being uniquely identifiable, comprising the steps of:
providing a server, wherein said server being connectable to said CED;
connecting remotely by a user device to said server via said networks;
providing by said user device to said server a content request for said CED, wherein said content request requesting a content and the content being located at one or more locations;
requesting by said server for the locations of the content;
fetching the content by said server from the locations of the content; and
providing the content by said server to said CED.

12. The method of claim 11 wherein said server is integrated with said CED.

13. The method of claim 11 wherein said CED is a television.

14. The method of claim 11 wherein said user device is a remote computer.

15. The method of claim 11 wherein said user device is a mobile phone.

16. The method of claim 11 wherein in the providing by said user device step, a user inputs said content request to a user interface displayed on said user device, where said user interface relays said content request to said server.

17. The method of claim 11 wherein in the providing by said user device step, a remote control for said CED is provided and a user inputs said content request through said remote control, where one or more alphanumeric characters are mapped to one or more buttons on said remote control.

18. The method of claim 17 wherein in the providing by said user device step, one or more possible phrase completions associated with the inputted content request is generated based on a sequence of button presses on said remote control by said user.

19. The method of claim 18 wherein in the providing by said user device step, said possible phrase completions are alphanumeric representations for non-English phrases.

20. A method for managing content for a television (“TV”) via one or more networks, wherein said TV being uniquely identifiable, comprising the steps of:
providing a server, wherein said server being connectable to said TV;
connecting remotely by a user device to said server via said networks, wherein said user device has a plurality of buttons;
providing by said user device to said server a content request for said TV, wherein said content request requesting a content and the content being located at one or more locations, wherein a user inputs said content request to said user device, where one or more alphanumeric characters are mapped to one or more buttons on said user device, wherein one or more possible phrase completions associated with the inputted content request is generated based on a sequence of button presses on said remote control by said user;
requesting by said server for the locations of the content;
providing by said server to said TV the locations of the content, wherein said locations are filtered based on the integrity of one or more blocks of said content and based on the quality of said locations; and
fetching the content by said TV from the locations of the content.
